(19) United States
(12) Patent Application Publication
(10) Pub. No.: US 2026/0262068 A1
(43) Pub. Date: Sep. 3, 2026

(54) SCHEDULING MULTIPLE CONFIGURED GRANT RESOURCES WITHIN A SINGLE CONFIGURED GRANT PERIOD

(71) Applicant: Lenovo (Singapore) Pte. Limited, Singapore (SG)

(72) Inventors: Joachim Löhr, Wiesbaden (DE); Prateek Basu Mallick, Dreieich (DE); Ravi Kuchibhotla, Chicago, IL (US)

(21) Appl. No.: 18/881,693

(22) PCT Filed: Jul. 6, 2023
(86) PCT No.: PCT/IB2023/056993

§ 371 Date: Jan. 6, 2025

Related U.S. Application Data
(60) Provisional application No. 63/367,773, filed on Jul. 6, 2022.

(51) Int. Cl. H04W 72/512

(52) U.S. Cl. CPC H04W 72/512

(57) ABSTRACT

Various aspects of the present disclosure relate to a user equipment (UE) for wireless communication, the UE having at least one memory and at least one processor coupled with the at least one memory and configured to cause the UE to: receive, from a base station, a configured grant (CG) configuration comprising a field that indicates an allocation of multiple configured grant (CG) uplink (UL) resources within each CG period; and use the multiple CG UL resources within a next CG period as configured UL grants. The field includes a parameter indicating a timing of additional CG UL resources within the CG period.

### PRIORITY APPLICATION

This application claims priority to U.S. Provisional Application No. 63/367,773 filed Jul. 6, 2022, this content of which is fully incorporated herein.

### TECHNICAL FIELD

The present disclosure relates to wireless communications, and more specifically to wireless communications scheduling to meet a data latency for video frame transmission.

### BACKGROUND

A wireless communications system may include one or multiple network communication devices, including base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, and other suitable radio access technologies beyond 5G.

A UE can communicate with a gNB to support extended Reality (XR) features. XR refers to all real-and-virtual combined environments and human-machine interactions generated by computer technology and wearables. XR is an umbrella term for different types of realities including Virtual reality (VR), Augmented reality (AR), and Mixed reality (MR), and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

### SUMMARY

The present disclosure relates to methods, apparatuses, and systems that support wireless communication for wireless communication by a user device with reduced jitter for latency-sensitive data, such as extended Reality (XR) traffic. The disclosure provides different solutions described in various embodiments for enhancing the logical channel prioritization (LCP) procedure to address quality of service (QoS) of an XR application. A user device considers a remaining delay budget that is associated with the data of a logical channel and that is available for an initial transmission. In particular, the user device determines an order for multiplexing into allocated resources of an uplink medium access channel (MAC) as a transport block (TB). Logical channel priority may be considered for cases when the remaining delay budget is the same for more than one logical channel or when no latency-sensitive data awaits initial transmission.

Some implementations of the method and apparatuses described herein may further include receiving, via a transceiver of the user device on a downlink from a network device, one or more control messages containing: (i) logical channel configuration of more than one logical channels, including a priority value associated with each logical channel; and (ii) an uplink resource allocation grant. The method includes tracking respective remaining delay budgets for each packet data unit (PDU) in one or more uplink buffers assigned to a corresponding one of the more than one logical channels. The method includes determining, on a medium access control layer, a multiplexing order of the PDUs of the more than one logical channels according to the associated remaining delay budget in increasing order starting with the PDU having smallest remaining delay budget. The method includes assigning resources allocated by the uplink grant to the logical channels according to the determined multiplexing order, starting with the logical channel having the PDU with the smallest remaining delay budget. The method includes generating an uplink signal by multiplexing the PDUs of the more than one logical channels according to the assigned resources.

Some implementations of the method and apparatuses described herein may further include a network device that incorporates, or a method that provides for, wireless communication with reduced jitter for latency-sensitive data in an uplink signal from a user device. The method includes transmitting, via a transceiver of a network device on a downlink to a user device, one or more control messages containing: (i) logical channel configuration of more than one logical channels, including a priority value associated with each logical channel; and (ii) an uplink resource allocation grant. The one or more control messages prompts the user device to track respective remaining delay budgets for each packet data unit (PDU) in one or more uplink buffers assigned to a corresponding one of the more than one logical channels. In addition, the one or more control messages prompts the user device to determine, on a medium access control layer, a multiplexing order of the PDUs of the more than one logical channels according to the associated remaining delay budget in increasing order, starting with the PDU having smallest remaining delay budget. The one or more control messages prompts the user device to assign resources allocated by the uplink grant to the logical channels according to the determined multiplexing order starting with the logical channel having the PDU with the smallest remaining delay budget. The method includes receiving from the user device, via the transceiver on the medium access control layer, an uplink signal containing the PDUs of the more than one logical channels multiplexed by the user device according to the assigned resources.

### BRIEF DESCRIPTION OF THE DRAWINGS

FIG. 1 presents an example of a wireless communications system enabling wireless communication that supports a logical channel procedure (LCP) that is enhanced for latency-sensitive traffic such as extended Reality (XR) traffic, in accordance with aspects of the present disclosure.

FIG. 2 presents a communication diagram of a downlink and an uplink illustrating aspects of a logical channel prioritization (LCP) procedure that considers remaining delay budget (RDB) and/or packet delay budget (PDB), in accordance with aspects of the present disclosure.

FIG. 3 presents a graphical plot of an amount of traffic or data buffered in respective logical channels of different assigned priorities, in accordance with aspects of the present disclosure.

FIG. 4 presents an example graphical plot of an implementation of the LCP procedure addressing strict delay requirements of logical channels carrying latency-sensitive data, in accordance with aspects of the present disclosure.

FIG. 5 presents a graphical plot of first, second, and third configured grants respectively, for early, on-time, and late uplink medium access channel (MAC) packet data units, in accordance with aspects of the present disclosure.

FIG. 6 presents an example graphical plot in which the logical channel prioritization procedure is used to begin assignment of traffic or data, in accordance with aspects of the present disclosure.

FIG. 7 presents an example graphical plot in which the logical channel prioritization procedure is used to complete assignment of traffic or data, in accordance with aspects of the present disclosure.

FIG. 8 presents an example of an information element that implements configuration grant configurations, in accordance with aspects of the present disclosure.

FIG. 9 presents an example of a block diagram of a user device that supports wireless communication with a network device by multiplexing latency-sensitive data in an uplink signal, in accordance with aspects of the present disclosure.

FIG. 10 presents an example of a block diagram of a network device that supports scheduling and receiving wireless communication that includes the uplink signal of multiplexed latency-sensitive data from the user device, in accordance with aspects of the present disclosure.

FIG. 11 presents a flowchart of a method performed by a user device that supports wireless communication of multiplexed uplink signal to meet a latency requirement appropriate for a portion of latency-sensitive data, in accordance with aspects of the present disclosure.

FIG. 12 presents a flowchart of a method performed by a network device that supports wireless communication of multiplexed uplink signal to meet a latency requirement appropriate for a portion of latency-sensitive data, in accordance with aspects of the present disclosure.

### DETAILED DESCRIPTION

As an example of latency-sensitive traffic, extended reality (XR) traffic between a radio access network (RAN) and a user equipment (UE) over an air interface is modeled as a packet delay budget (PDB). The PDB is a limited time budget for a data packet to be transmitted over the air from a base node to the UE or from the UE to the base node. A delay budget can be also defined for an Application Data Unit (ADU). An ADU is the smallest unit of data that can be processed independently by an application, such as processing for handling out-of-order traffic data.

Virtual Reality (VR) is a rendered version of a delivered visual and audio scene. The rendering is designed to mimic the visual and audio sensory stimuli of the real world as naturally as possible to an observer or user as they move within the limits defined by the application. Augmented reality (AR) provides a user with additional information, artificially generated items, or content overlaid upon their current environment. Mixed reality (MR) is an advanced form of AR where some virtual elements are inserted into the physical scene with the intent to provide the illusion that these elements are part of the real scene.

In the field of video compression, a video frame is compressed using different algorithms with different advantages and disadvantages, centered mainly around the amount of data compression. These different algorithms for video frames are called picture types or frame types. The three major picture types used in the different video algorithms are I, P and B. The picture types are different in the following characteristics: (i) Intra-coded (I)-frames are the least compressible but don't require other video frames to decode; (ii) Predicted (P)-frames can use data from previous frames to decompress and are more compressible than I-frames; and (iii) Bi-directional predicted (B)-frames can use both previous and forward frames for data reference to get the highest amount of data compression. XR traffic has a number of characteristics: (i) variable packet arrival rate: packets coming at 30-120 frames/second, with some jitter; (ii) packets having variable and large packet size; (iii) B/P-frames being dependent on I-frames, and (iv) presence of multiple traffic/data flows such as pose and video scene in uplink. A delay budget for video frame ADUs is especially important in XR traffic because of decoding requirements of video content. A video frame can be an I-frame, P-frame, or can be composed of I-slices, and/or P-slices. I-frames/I-slices are more important and larger than P-frames/P-slices. The importance is related to impact of late traffic on the ability to successfully decode and use the traffic.

The current specific logical channel prioritization (LCP) procedure is based on statically configured parameters such as logical channel priority. However, those static prioritization rules may not be sufficient to satisfy strict latency requirements of an XR application. For example, currently the LCP procedure does not consider the remaining delay budget of data that is pending for transmission when assigning resources of an uplink to logical channels (LCHs). Latency-sensitive traffic arriving after expiration of the remaining delay budget may not be usable, degrading presentation of content, for example, and thus reduces a user experience. “User Experience” refers to the overall performance sense a user of the communication device or periphery device experiences when using a product, application, system, or service. Within the context of the disclosure, user experience is a broad term that can cover anything from how well the user can navigate the product, how easy the device or product is to use, how relevant the content displayed is, etc. Some immersive user interfaces, such as XR displays, have demanding communication requirements. User experience is reduced when the presentation of images is noticeably degraded due to inadequate data throughput or excessive data latency.

The present disclosure provides solutions that may be used individually or in combination to enhance the LCP procedure for latency-sensitive traffic such as for an XR application. The enhanced LCP procedure maintains a quality of service (QoS) required for the latency-sensitive traffic while retaining a capability to revert back to logical channel prioritization. A user device considers the remaining delay budget associated with the traffic or data of a logical channel (LCH) being available for an initial transmission to determine an order for multiplexing priority in a transport block (TB) on medium access control (MAC) layer. For latency-sensitive data, logical channel priority is only considered for cases when the remaining delay budget is the same for more than one LCH.

In one embodiment, the user device implements the enhanced LCP procedure for multiplexing data on physical uplink shared channel (PUSCH) resources allocated or reserved for XR traffic. MAC entity/UE considers the remaining delay budget (RDB) of the data of the LCHs that is available for transmission to determine the order in which LCH data is multiplexed on the uplink resources. Traffic or data with the most stringent remaining delay budget (i.e., lowest remaining RDB) is prioritized and thus multiplexed first on the PUSCH resources.

In another embodiment, the present disclosure introduces a new field within downlink control information (DCI) allocating uplink (UL) resources (“UL DCI”) for an initial transmission. The new field indicates whether the MAC should use the enhanced LCP procedure for latency-sensitive data or revert back to allocation based on LCH priorities. When the field indicates the former prioritization of latency-sensitive traffic, remaining delay budget (RDB) or packet delay budget (PDB) is then used to prioritize and multiplex the traffic to allocated resources of the MAC layer during the LCP procedure. In one example, the new DCI field is a one-bit flag.

In an additional embodiment, the present disclosure introduces a configured grant (CG) optimized for latency-sensitive traffic or data (e.g., XR traffic) by allocating multiple CG resource allocations within each CG period. According to one implementation of the embodiment, a new parameter within the CG configuration indicates the timing of the additional CG resources within a CG period. In one example, the new parameter is a field indicating the maximum jitter expected for the latency-sensitive traffic or data that is mapped to the CG configuration. According to one example, the CG configuration allocates additional configured grant resources ‘x’ slots before and ‘y’ slots after the CG resources. The user device uses the next available one of the additional configured grant resources, with any remaining resources thereafter being available for the network device to reschedule. The CG configuration reduces latency by accommodating the jitter within a single CG period and not having to potentially wait too long to reschedule uplink transmission in a subsequent CG period.

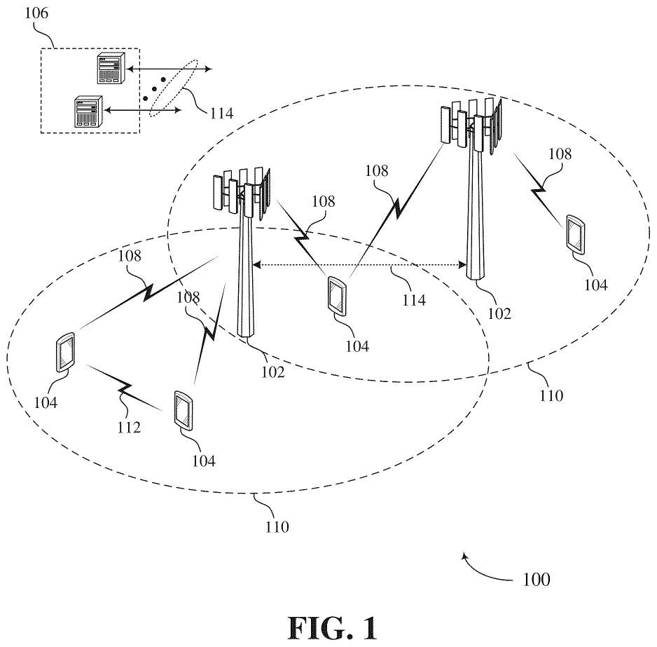

FIG. 1 presents an example of a wireless communications system 100 enabling wireless communication that supports an LCP enhanced for latency-sensitive traffic such as XR traffic, in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a New Radio (NR) network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, may include, or may be referred to as a base transceiver station, an access point, a NodeB, an eNodeB (eNB), a next-generation NodeB (gNB), a network device, or other suitable terminology. A base station 102 and a UE 104 may communicate via a communication link 108, which may be a wireless or wired connection. For example, a base station 102 and a UE 104 may wirelessly communicate over a user to user (Uu) interface.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

In the description that follows, the timing of transmissions and retransmissions of control channels and data channels supports latency and/or error rate requirements for portions of video frames and may be referred to as time units. Time units, such as a symbol, slot, subslot, and transmission time interval (TTI), can have a particular duration. In an example, a symbol could be a fraction or percentage of an orthogonal frequency division multiplexing (OFDM) symbol length associated with a particular subcarrier spacing (SCS). In another example, an uplink (UL) transmission burst can be comprised of multiple transmissions. The multiple transmission can have the same priority, different priorities, or may have no associated priority. The multiple transmissions may include gaps between the transmissions that are short enough in duration to not necessitate performing a channel sensing or listen before transmit (LBT) operation between the transmissions.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface. PC5 refers to a reference point where the UE 104 directly communicates with another UE 104 over a direct channel without requiring communication with the base station 102.

A base station 102 may support communications with the core network 106, or with another base station 102, or both. For example, a base station 102 may interface with the core network 106 through one or more backhaul links 114 (e.g., via an S1, N2, or another network interface). The base stations 102 may communication with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). An ANC may communication with the one or more UEs 104 through one or more other access network transmission entities, which may be referred to as a radio heads, smart radio heads, or transmission-reception points (TRPs).

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

Some implementations of the method and apparatuses described herein may further include signaling or a handshake between a base node, such as base stations 102, and a user device, such as UEs 104, that indicate which transport blocks (TBs) are associated with a packet and/or an application data unit (ADU). In an example, the signaling or handshake can be downlink control information (DCI) indication or a medium access control (MAC) control element (CE) indication. In one or more embodiments, the base node and device can use a priority indication for priority of particular types of video transmission. In an example, I-frame/slice can have high priority and P-frame/slice may have low priority.

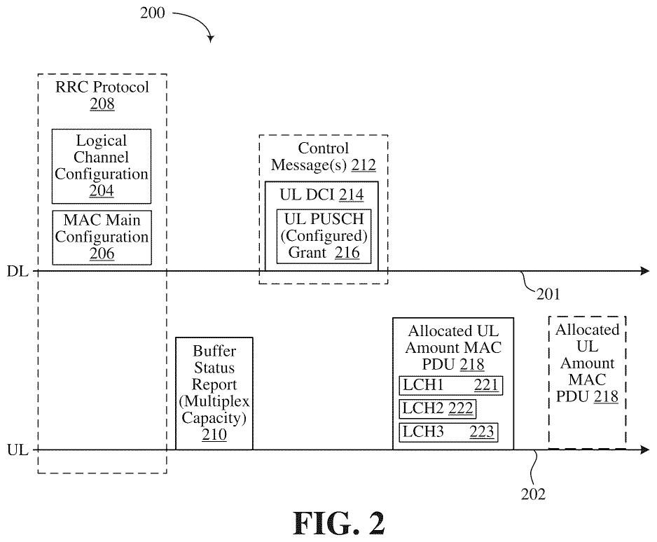

FIG. 2 presents communication diagram 200 of a downlink 201 and an uplink 202 that illustrate aspects of a logical channel prioritization (LCP) procedure that considers remaining delay budget (RDB) and/or packet delay budget (PDB). The downlink 201 includes a logical channel configuration message 204 and a medium access control (MAC) main configuration message 206 as part of radio resource control (RRC) protocol 208 that establish the data communication. The uplink 202 includes periodic buffer status reports 210 that indicate an amount of traffic or data that requires an uplink allocation. The buffer status reports 210 may indicate a multiplex capacity to prompt authorization for prioritizing multiplexing of traffic or data on the uplink 202 according to remaining delay budget for latency-sensitive data such as XR traffic. The buffer status reports 210 may alternatively not indicate a multiplex capacity when latency-sensitive data is not buffered, prompting for reversion to multiplexing traffic or data on the uplink 202 based on logical channel priorities. Control message(s) 212 on the uplink 202 can include uplink (UL) downlink control information (DCI) 214 such as an UL PUSCH Grant 216 defining an allocated UL amount MAC PDU 218 to carry portions of a first logical channel (LCH1) 221, a second logical channel (LCH2) 222, and a third logical channel (LCH3) 223. In one or more embodiments, the UL PUSCH Grant 216 provides a configured grant, enabling selection of two or more allocated UL amount MAC PDUs 218 to accommodate jitter in the availability of the buffered data for an uplink signal.

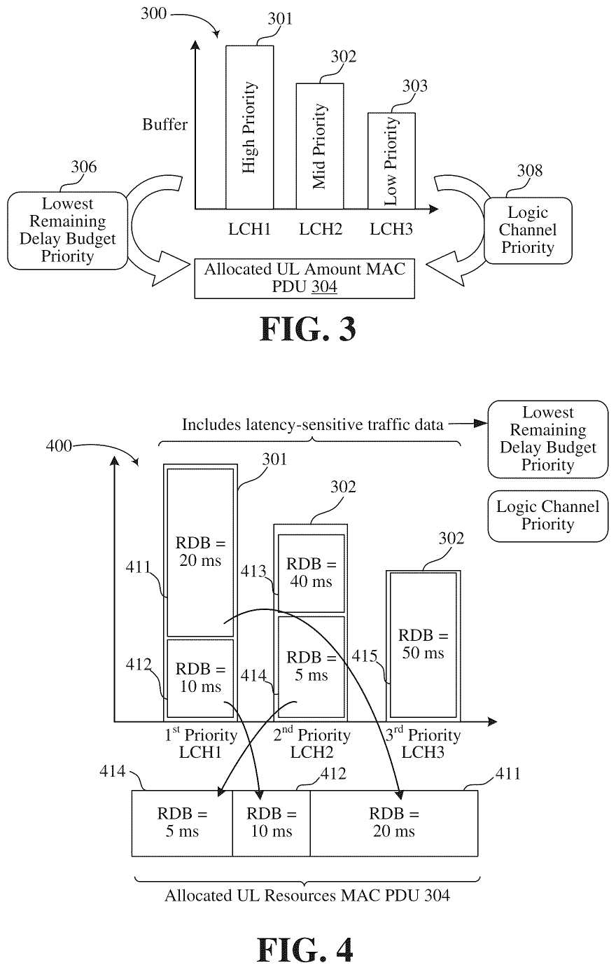

FIG. 3 presents a graphical plot 300 of an amount of traffic or data buffered in respective logical channels of different assigned priorities. Portions of the traffic or data are assigned to an allocated uplink amount MAC PDU 304. For clarity, three LCHs are depicted, each having an assigned priority: (i) first logical channel (LCH1) 301 is assigned a highest priority (e.g., priority=1); (ii) second logical channel (LCH2) 302 is assigned a mid-priority (e.g., priority=2); and (iii) third logical channel (LCH3) 303 is assigned a lowest priority (e.g., priority=3). Traffic or data buffered in LCH1 301, LCH2 302, and LCH3 303 are assigned to a MAC PDU allocated by an uplink grant 304. In particular, the traffic or data is assigned according to either a lowest RDB priority 306 or according to LCH priority 308 depending upon the presence of latency-sensitive data (e.g., XR traffic).

FIG. 4 presents an example graphical plot 400 of an implementation of the LCP procedure addressing strict delay requirements of LCH(s)/DRB(s) carrying latency-sensitive data such as XR traffic/applications, which are also referred to as XR bearers/LCHs. LCH1 301 buffers a first PDU 411 having RDB of 20 ms and a second PDU 412 having RDB of 10 ms. LCH2 302 buffers a third PDU 413 having RDB of 40 ms and a fourth PDU414 having RDB of 5 ms. LCH3 303 buffers a fifth PDU 415 having RDB of 50 ms. Allocating based on lowest RDB, fourth PDU 414, second PDU 412, and first PDU 411 are assigned to the allocated uplink resources defined by the MAC PDU grant 304.

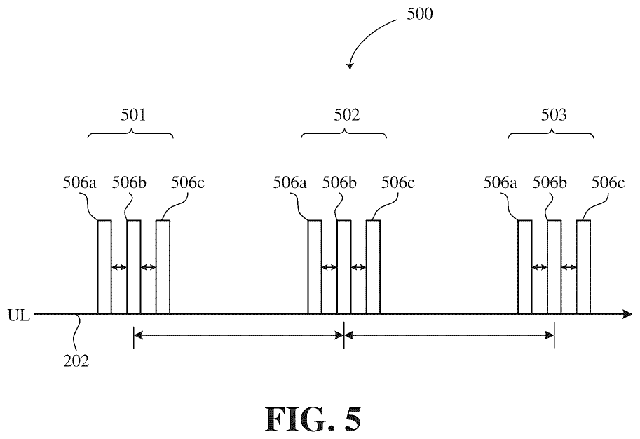

FIG. 5 presents a graphical plot 500 of first, second, and third configured grants 501, 502, and 503 respectively for early, on-time, and late UL MAC PDUs 506a, 506b, and 506c that can be utilized on the uplink 202. The spacing between UL MAC PDUs 506a, 506b, and 506c is based on the amount of expected jitter in receipt of the traffic or data to transmit on the uplink 202.

In one or more embodiments, the LCP procedure retains a capability to revert to LCH prioritization based on LCH priorities when latency-sensitive data is not present. In particular, when operating the LCP procedure in this reverted mode, “normal” data that is less latency sensitive than XR traffic is buffered and available for uplink transmission. The LCP procedure reverts to considering priorities of the LCHs that are entitled to multiplex data onto uplink resources allocated by an uplink resource allocation (grant). The set of LCHs that is allowed to map data to an UL resource is determined by the configured LCH restrictions. In particular, only those LCHs that satisfy all the configured LCH restrictions are considered for the subsequent multiplexing by the LCP procedure. UL resources are allocated to the LCHs in a strict priority order, starting with the highest priority LCH.

For this reversion in the LCP procedure, the UE shares UL resources among the configured LCHs based on the LCH priority and the prioritized bit rate configured for an LCH. The idea behind prioritized bit rate is to support a minimum bit rate for each logical channel, including low priority non-GBR (Guaranteed Bit Rate) bearers, in order to avoid a potential starvation. Each bearer should at least get enough resources to achieve the prioritized bit rate (PBR). The LCP procedure includes an initial step of selecting the LCHs for TB generation based on the configured LCH restrictions. Thereafter, the LCP procedure is in general specified as a “two-step” procedure. In the first step, the LCHs are served (in decreasing priority order, starting with the highest priority logical channel) up to their configured PBR (implemented by means of a token bucket model). In the second step of the LCP, if any uplink resources remain (after meeting the PBR of the LCHs in the first round), all the logical channels are served in a strict decreasing priority order (regardless of the value of bucket) until either the data for that logical channel or the UL grant is exhausted.

According to one embodiment, when delay budget considerations are not applicable or the same for particular PDUs, the UE may revert to using a preset categorization of priority order when performing the LCP procedure. In an example, the logical channels may be prioritized in accordance with the following order with the highest priority listed first:
(a) C-RNTI MAC CE or data from UL-CCCH;
(b) Configured Grant Confirmation MAC CE or MAC CEs for BFR or Multiple Entry Configured Grant Confirmation MAC CE;
(c) Sidelink Configured Grant Confirmation MAC CE;
(d) LBT failure MAC CE;
(e) MAC CE for SL-BSR prioritized according to clause 5.22.1.6;
(f) MAC CE for BSR, with exception of BSR included for padding;
(g) Single Entry PHR MAC CE or Multiple Entry PHR MAC CE;
(h) MAC CE for the number of Desired Guard Symbols;
(i) MAC CE for Pre-emptive BSR;
(j) MAC CE for SL-BSR, with exception of SL-BSR prioritized according to clause 5.22.1.6 and SL-BSR included for padding;
(k) data from any Logical Channel, except data from UL-CCCH;
(l) MAC CE for Recommended bit rate query;
(m) MAC CE for BSR included for padding; and
(n) MAC CE for SL-BSR included for padding.

Note that prioritization among Configured Grant Confirmation MAC CE, Multiple Entry Configured Grant Confirmation MAC CE, and MAC CEs for BFR is up to UE implementation.

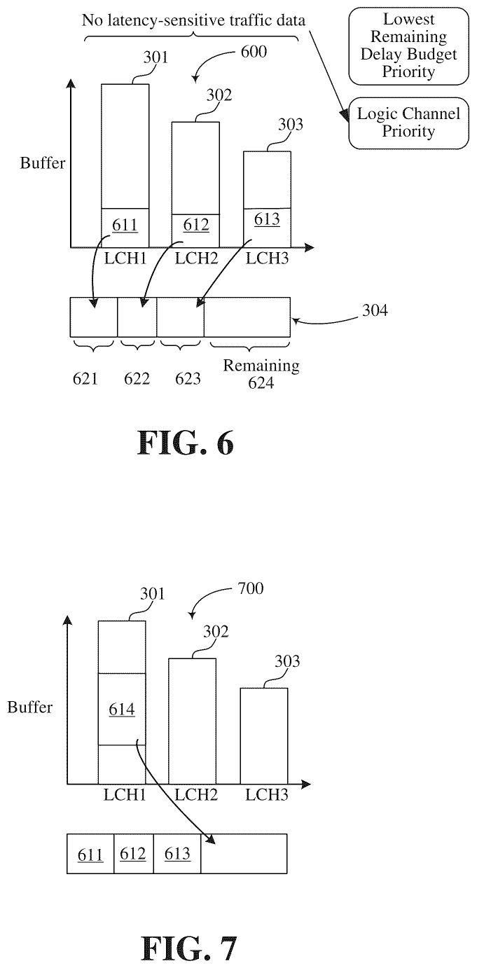

FIG. 6 presents an example graphical plot 600 in which the logical channel prioritization procedure is used to begin assignment of traffic or data. The selection process includes first selecting first data/PDU 611 from LCH1 301 as a first assignment 621 of UL MAC PDU 304. Then, second data/PDU 612 from LCH2 302 is selected as a second assignment 622 of UL MAC PDU 304. Then, third data/PDU 613 from LCH3 303 is selected as a third assignment 623 of UL MAC PDU 304, leaving remaining assignment 624.

FIG. 7 presents an example graphical plot 700 in which the logical channel prioritization procedure is used to complete assignment of traffic or data. In a second pass of the selection process after selection of first, second, and third PDUs 611-613, LCH priority is used to select a corresponding amount of LCH1 301 as fourth data/PDU 614 to fill remaining assignment 624 (i.e., “fourth” assignment”).

Many of the XR and cloud computing use cases are characterized by quasi-periodic traffic (with possible jitter) with high data rate in DL (i.e., video steam) combined with the frequent UL (i.e., pose/control update) and/or UL video stream. Both DL and UL traffic are also characterized by relatively strict packet delay budget (PDB). In order to support a sufficiently high capacity, i.e., number of served UEs which fulfil the service requirements, it is important to ensure that packets are received within the projected delay budget, e.g., PDB or ADU delay budget. Since an application layer does not benefit from packets that are received beyond its PDB, i.e., packets are dropped, it is of vital importance that data packets are successfully received within the associated delay boundaries.

According to one embodiment, gNB allocates, to a UE, UL resources that are reserved for data of XR bearers, i.e., data of LCHs that are configured for XR traffic/applications. Those uplink resources are exclusively reserved for XR bearers/LCHs. That is, data of other LCHs that are not configured for XR traffic/applications are scheduled on other UL-SCH resources. According to one implementation of this embodiment, those uplink resources which are reserved for XR data are configured uplink grant resources (CG PUSCH resources). Configured grants may be suitable for UL traffic for XR applications. In an example, the XR applications may produce uplink data that is quasi-periodic traffic, such as pose or control updates. By means of existing LCH restrictions, i.e., LCH to CG mapping configuration, it may be ensured that only specific LCHs, e.g., XR bearers/LCHs, are allowed to multiplex data on the CG PUSCH resources allocated for XR traffic.

According to one embodiment, UE uses a new LCP procedure for multiplexing data on PUSCH resources allocated/reserved for XR traffic. According to one implementation of this embodiment, UE uses the remaining delay budget (RDB) of the data of the LCHs that is available for transmission i to determine the order in which LCH data is multiplexed on the UL resources. UE does not revert to considering the LCH priority when determining the order and the amount of resources allocated to the XR LCHs or bearers. A principle of these new LCP multiplexing rules is that data with the most stringent remaining delay budget, e.g., lowest remaining RDB, should be prioritized and multiplexed first on the PUSCH resources. In particular, the LCHs are ordered according to their remaining delay budget (RDB), or latency bound, starting with the LCH having data with the lowest remaining delay budget or shortest latency bound in ascending order. Essentially the remaining delay budget or latency bound is used as the main parameter instead of the logical channel priority for the LCP procedure.

One advantage of this scheme is that the “multiplexing priority” of a LCH during the LCP procedure is not static, as with the logical channel priority, which is a parameter associated with the LCHs. Instead, the multiplexing priority changes depending on the time data of a LCH that is pending in the UE for transmission. The lower the remaining delay budget is then the higher the “multiplexing priority” of the data during the LCP procedure. Essentially, the mechanism adapts the multiplexing priority depending on the remaining delay budget. Thus, the multiplexing priority inherently reflects the urgency of the data. Different data packets, e.g., radio link control (RLC) PDU(s), of one LCH might have a different associated remaining delay budget and hence a different multiplexing priority. As a consequence, different data packets of the same LCH are treated with a different multiplexing priority during the LCP procedure. According to one implementation of the embodiment, each RLC SDU of a LCH is associated with a parameter, which denotes the remaining delay budget.

According to one implementation of this embodiment, UE/MAC uses the logical channel priority for cases when the data of multiple LCHs pending in the buffer for transmission have the same remaining delay budget. In this case, UE could prioritize the data with the higher LCH priority when allocating resources to the different LCHs, i.e., during LCP procedure. In this implementation, the LCH priority is used as a second level parameter for determining the multiplexing priority.

According to some alternative implementation of this embodiment, the UE determines which of the LCHs to prioritize during the LCP procedure when the data of multiple LCHs pending in the buffer for transmission have the same remaining delay budget. Alternatively, or in addition, UE may prioritize the LCH with the larger amount of data for cases when the data of multiple LCHs pending in the buffer for transmission have the same remaining delay budget. The motivation for this implementation is the maximization of data transmission.

According to one embodiment, MAC control elements (“MAC CE(s)”) are configured with an upper delay bound, e.g., also referred to as a delay budget. When multiplexing data in the MAC layer on the scheduled uplink resources, the UE enforces the upper delay bound specified for MAC CEs during the LCP procedure. In particular, the UE treats the MAC CEs the same as an LCH. The remaining delay budget of a MAC CE is considered as a criterion for determining the multiplexing priority, as described in the previous embodiment. The delay budget of a MAC CE may be fixed in the standard or configured by a higher layer, such as the radio resource control (RRC) layer. According to one implementation of the embodiment, a default delay budget is assumed for the MAC CEs during LCP procedure.

According to one embodiment, UE uses a different relative priority order when performing the LCP procedure for an initial UL transmission on UL resources allocated for XR traffic compared to the relative priority order currently specified. According to one implementation of this embodiment, UE/MAC prioritizes data of LCHs that are allowed to be multiplexed on UL resources allocated for XR traffic/data over MAC CEs. That is, LCHs have a higher multiplexing priority than MAC CEs and are granted UL resources before MAC CEs.

In one embodiment, UE uses the LCH priority during LCP in order to determine the order and the amount of resources allocated to each LCH. For cases when two LCHs have the same LCH priority, UE/MAC uses the RDB of the data in order to determine the multiplexing priority, i.e., which data to put first into the TB. According to this embodiment, UE uses the legacy LCP procedure for UL grants, with the enhancement that RDB of the data is used in addition to the logical channel priority for determining the order in which data of the LCHs is multiplexed into a TB.

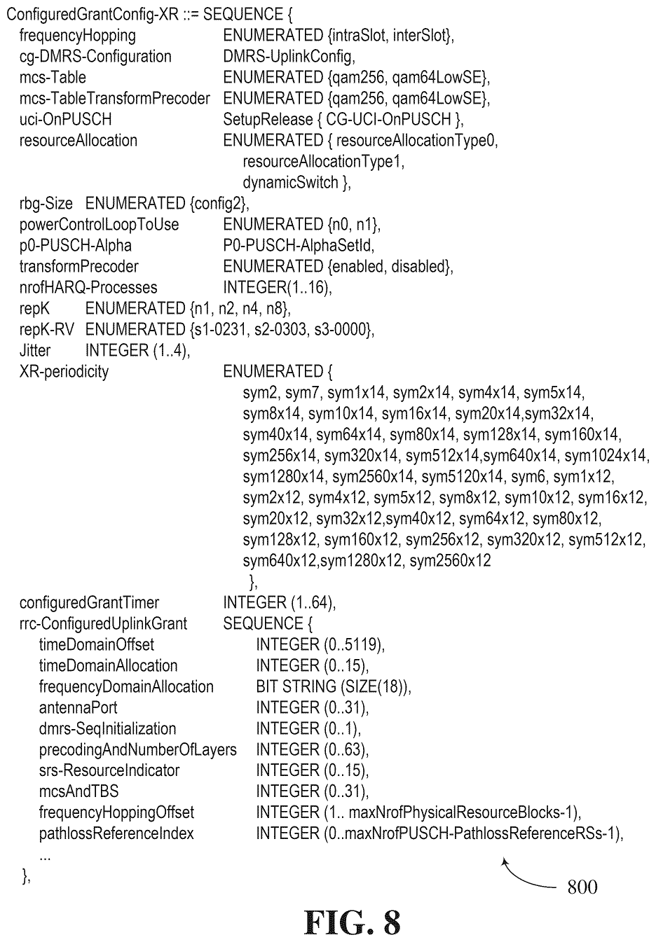

According to one embodiment, configured grant configurations for UL transmissions are configured specifically for XR data/traffic. A new information element (IE) is introduced, which configures semi-persistent UL resources, e.g., CG-PUSCH resources for XR traffic. Some of the parameters of this new IE could be similar to the legacy configured grant configurations. In one example, new parameters that are XR specific (e.g., new periodicities, jitter parameter, delay parameter, etc.) may be contained within the XR-specific CG configuration IE. FIG. 8 provides an example code segment of the new IE 800 that implements configuration grant configurations (“ConfiguredGrantConfig”) in addition to configuring other aspects of the LCP procedure.

According to one embodiment, a newly introduced CG configuration, e.g., CG configuration optimized for XR data/traffic, allocates multiple CG resource allocations within each CG period. According to one implementation of the embodiment, a new parameter within the CG configuration indicates the timing of the additional CG resources within a CG period. In one example, the new parameter is a field indicating the maximum jitter expected for the data that is mapped to the CG configuration. According to one example, the CG configuration allocates additional configured grant resources ‘x’ slots before and ‘y’ slots after the CG resources that are determined according to a generally-known formula given in the legacy specifications.

After an uplink grant is configured for a configured grant Type 1, the UE, in managing the MAC layer, identifies a sequence of available uplink grants 1-N that sequentially occur in the symbol according to following calculation:

$$( System Frame Number ( SFN ) \times number of Slots per Frame \times number of Symbols per Slot ) + ( slot number in the frame \times number of Symbols per Slot ) + symbol number in the slot ) = ( time Reference SNF \times number of Slots per Frame \times Number of Symbols per Slot + Time Domain Offset \times Number of Symbols per Slot + S + N \times periodicity ) modulo ( 1024 \times number of Slots per Frame \times number of Symbols per Slot )$$

After an uplink grant is configured for a configured grant Type 2, the UE, in managing the MAC layer, identifies a sequence of available uplink grants 1-N that sequentially occur in the symbol according to following calculation:

$$( SFN \times number of Slots per Frame \times number of Symbols per Slot ) + ( slot number in the frame \times number of Symbols per Slot ) + symbol number in the slot ) = ( {SNF}_{start} time \times number of Slots per Frame \times number of Symbols per Slot + {slot}_{start time} \times number of Symbols per Slot + {symbol}_{start time} ) + N \times periodicity ] modulo ( 1024 \times number of Slots per Frame \times number of Symbols per Slot )$$

where SFN_{start time}, slot_{start time}, and symbol_{start time} are the SFN, slot, and symbol, respectively, of the first transmission opportunity of PUSCH where the configured uplink grant was (re)initialized.

According to one implementation of the embodiment, ‘x’ and ‘y’ are configured within the CG configuration IE and correspond to the minimum respectively maximum jitter. The additional CG resources are configured in order to cope with the varying packet arrival time due to jitter effect.

In another example, the new GG configuration introduced for XR traffic allocates an additional CG resource/grant ‘x’ slots or ms after the CG occasions, defined according to the legacy formula. The additional CG resource allocated ‘x’ slots/ms after the ‘legacy’ CG resources addresses the late packet arrival.

According to one implementation of the embodiment, UE deactivates/skips the remaining CG resources allocated within the same CG period (if any) following an UL transmission on one of the CG resources. For example, if UE has been allocated three CG resources within a CG period in order to handle early and late packet arrivals and UE transmits an early arrived packet on the first of the 3 CG resources, e.g., on the CG resources allocated ‘x’ slots/ms before the CG resources determined by the formula, UE will not perform an UL transmission on the remaining 2 CG resources. UE may explicitly notify the gNB that it will not use the remaining CG resources within the CG period such that gNB can allocate the resource(s) to other UEs.

According to one embodiment, a LCH is configured as a LCH carrying XR traffic/data. A new field/IE within the IE “logicalchannelconfig” indicates whether the LCH carries data/traffic of an XR application. According to one implementation of this embodiment, UE/MAC is only allowed to multiplex data of LCHs, which are configured as LCH carrying XR traffic/data onto UL resources that are allocated for XR data/traffic. In one implementation, UE is only allowed to multiplex data of LCHs, which are configured as a LCH carrying XR traffic/data onto CG PUSCH resources configured for XR data/traffic.

According to one implementation of this embodiment, in addition to allowing the UE to multiplex data of LCHs configured for XR data/traffic, the UE is also allowed to multiplex data of LCHs that is not configured for XR data/traffic. A new LCH restriction is introduced, according to this implementation of the embodiment. The LCH having the highest multiplexing priority, i.e., LCH for which data is multiplexed first in a TB, determines whether only XR traffic or also other traffic can be multiplexed in the TB. In one example, UE is allowed to multiplex data of LCHs configured for XR traffic onto UL resources that are not exclusively allocated/reserved for XR data/traffic.

According to one embodiment, an LCH/radio bearer is configured with a new field/IE which indicates whether the UE/MAC uses the remaining delay budget (RDB) of the data of the LCH in order to determine the order in which LCH data is multiplexed on the UL resources during LCP, e.g., multiplexing priority. In one example, the field is a Boolean parameter which, if set to true, indicates that RDB should be used for determining the multiplexing priority. In case the field/IE is set to false or not present, UE/MAC shall use the logical channel priority as in the legacy LCP procedure in order to determine the multiplexing order.

According to one aspect, the highest priority logical channel determines the type of prioritization mechanism used during LCP, e.g., RDB based or priority-based. Additionally in another aspect, the Grant indicates the type of prioritization mechanism to be used during the LCP procedure, und the UE considers only those LCHs for the LCP which are configured accordingly.

According to one embodiment, a new IE/field in the MAC configuration is introduced, e.g., MAC main configuration, which indicates whether UE shall use the RDB or the logical channel priority for the determination of the multiplexing order.

According to one embodiment, a DCI allocating UL resources (UL DCI) for an initial transmission indicates, within a field, whether the MAC should use the new LCP mechanism using the RDB in order to determine the order in which LCHs are allocated resources or whether the MAC should use the logical channel priority (as in legacy) during the LCP procedure. In one example, the field is a one-bit flag. In response to receiving an UL DCI, where the flag indicates that the RDB should be used as the parameter for determining the multiplexing priority, UE/MAC considers only those LCHs that are allowed to multiplex data on the resources allocated for XR traffic/data, and UE/MAC performs the LCP procedure as outlined in the previous embodiments, i.e., considering the RDB of the data of the LCHs in order to determine the multiplexing order. In one example, UE considers only those LCHs configured by the network for multiplexing order to the MAC according to RDB in the presently presented LCP procedure. In another example, UE considers only those LCHs that are configured as XR LCHs/bearers for multiplexing order to the MAC according to RDB in the presently presented LCP procedure. In an additional example, the UE may only multiplex data of LCHs in a TB for which the same LCP multiplexing rules are configured, e.g., RDB based or LCH priority based.

According to one implementation of the embodiment, a 2-bit field is signaled within the DCI allocation UL resources for an initial transmission. Four (4) different combinations are signaled within the new 2-bit field. In one example, the following combinations are signaled:
00: use normal/legacy LCP for all data-type
01: grant only for XR LCHs and use RDB
10: grant only for XR LCHs but LCP is used
11: grant not for XR LCHs

According to one implementation of this embodiment, UE/MAC uses the logical channel priority for cases when the data of multiple LCHs pending in the buffer for transmission have the same remaining delay budget. In this case, UE could prioritize the data with the higher LCH priority when allocating resources to the different LCHs, i.e., during LCP procedure. In this implementation, the LCH priority is used as a second level parameter for determining the multiplexing priority.

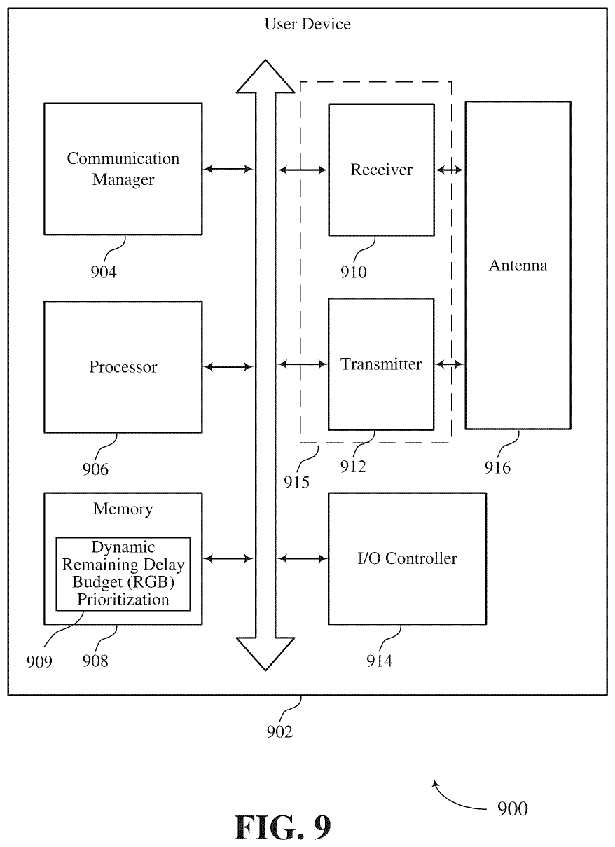

FIG. 9 presents an example of a block diagram 900 of a user device 902 that provides for wireless communication with a network device by multiplexing latency-sensitive traffic such as XR traffic in an uplink signal, in accordance with aspects of the present disclosure. The user device 902 may be an example of a UE 104, as described herein. The user device 902 may support wireless communication with one or more base stations 102, UEs 104, or any combination thereof. The user device 902 may include components for bi-directional communications including components for transmitting and receiving communications, such as a communication manager 904, a processor 906, a memory 908, a receiver 910, a transmitter 912, and an I/O controller 914. These components may be in electronic communication or otherwise coupled (e.g., operatively, communicatively, functionally, electronically, electrically) via one or more interfaces (e.g., buses). The receiver 910 and transmitter 912 may exist on a same chip and be collectively referred to as a transceiver 915.

The communication manager 904, the receiver 910, the transmitter 912, or various combinations thereof or various components thereof may be examples of means for performing various aspects of the present disclosure as described herein. For example, the communication manager 904, the processor 906, the receiver 910, the transmitter 912, or various combinations or components thereof may support a method for performing one or more of the functions described herein. In an example, the processor 906 executes a dynamic RGB prioritization application that configures the communication manager 904 to perform an enhanced LCP procedure for either prioritizing latency-sensitive data for assignment to an uplink signal or reverting to LCH prioritization for other traffic or data.

In some implementations, the communication manager 904, the receiver 910, the transmitter 912, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 906 and the memory 908 coupled with the processor 906 may be configured to perform one or more of the functions described herein (e.g., by executing, by the processor 906, instructions stored in the memory 908).

Additionally, or alternatively, in some implementations, the communication manager 904, the receiver 910, the transmitter 912, or various combinations or components thereof may be implemented in code (e.g., as communications management software or firmware) executed by the processor 906. If implemented in code executed by the processor 906, the functions of the communication manager 904, the receiver 910, the transmitter 912, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communication manager 904 may be configured to perform various operations (e.g., receiving, monitoring, transmitting) using or otherwise in cooperation with the receiver 910, the transmitter 912, or both. For example, the communication manager 904 may receive information from the receiver 910, send information to the transmitter 912, or be integrated in combination with the receiver 910, the transmitter 912, or both to receive information, transmit information, or perform various other operations as described herein. Although the communication manager 904 is illustrated as a separate component, in some implementations, one or more functions described with reference to the communication manager 904 may be supported by or performed by the processor 906, the memory 908, or any combination thereof. For example, the memory 908 may store code, which may include instructions executable by the processor 906 to cause the user device 902 to perform various aspects of the present disclosure as described herein, or the processor 906 and the memory 908 may be otherwise configured to perform or support such operations.

The processor 906 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 906 may be configured to operate a memory array using a memory controller. In some other implementations, a memory controller may be integrated into the processor 906. The processor 906 may be configured to execute computer-readable instructions stored in a memory (e.g., the memory 908) to cause/configure the user device 902 to perform various functions of the present disclosure.

The memory 908 may include random access memory (RAM) and read-only memory (ROM). The memory 908 may store computer-readable, computer-executable code including instructions that, when executed by the processor 906 cause the user device 902 to perform various functions described herein. The code may be stored in a non-transitory computer-readable medium such as system memory or another type of memory. In some implementations, the code may not be directly executable by the processor 906 but may cause/configure a computer (e.g., when the code is compiled and executed) to perform functions described herein. In some implementations, the memory 908 may include, among other things, a basic I/O system (BIOS) which may control basic hardware or software operation such as the interaction with peripheral components or devices.

The I/O controller 914 may manage input and output signals for the user device 902. The I/O controller 914 may also manage peripherals not integrated into the user device 902. In some implementations, the I/O controller 914 may represent a physical connection or port to an external peripheral. In some implementations, the I/O controller 914 may utilize an operating system such as iOS®, ANDROID®, MS-DOS®, MS-WINDOWS®, OS/2®, UNIX®, LINUX®, or another known operating system. In some implementations, the I/O controller 914 may be implemented as part of a processor, such as the processor 906. In some implementations, a user may interact with the user device 902 via the I/O controller 914 or via hardware components controlled by the I/O controller 914.

In some implementations, the user device 902 may include a single antenna 916. However, in some other implementations, the user device 902 may have more than one antenna 916, which may be capable of concurrently transmitting or receiving multiple wireless transmissions. The receiver 910 and the transmitter 912 may communicate bi-directionally, via the one or more antennas 916, wired, or wireless links as described herein. For example, the receiver 910 and the transmitter 912 may represent a wireless transceiver and may communicate bi-directionally with another wireless transceiver. The transceiver may also include a modem to modulate the packets, to provide the modulated packets to one or more antennas 916 for transmission, and to demodulate packets received from the one or more antennas 916.

In an example, the communication manager 904 may support wireless communication at a first device (e.g., the user device 902) in accordance with examples as disclosed herein. The communication manager 904 may be configured as or otherwise support wireless communication with a network device, such as a base station 102 (FIG. 1). The transceiver 915 includes at least one receiver 910 and at least one transmitter 912 that enable the user device 902 to communicate with the network device. The communication manager 904 is communicatively coupled to the transceiver 915. The processor 906 executes a dynamic RDB prioritization application 909 that configures the communication manager 904 to perform aspects of the present disclosure. In one or more embodiments, the communication manager 904 receives, via the transceiver 915 on a downlink from the network device, one or more control messages containing: (i) logical channel configuration of more than one logical channels, including a priority value associated with each logical channel; and (ii) an uplink resource allocation grant. The communication manager 904 tracks respective remaining delay budgets for each packet data unit (PDU) in one or more uplink buffers assigned to a corresponding one of the more than one logical channels. The communication manager 904 determines, on a medium access control layer, a multiplexing order of the PDUs of the more than one logical channels according to the associated remaining delay budget in increasing order starting with the PDU having smallest remaining delay budget. The communication manager 904 assigns resources allocated by the uplink grant to the logical channels according to the determined multiplexing order starting with the logical channel having the PDU with the smallest remaining delay budget. The communication manager 904 generates an uplink signal by multiplexing the PDUs of the more than one logical channels according to the assigned resources.

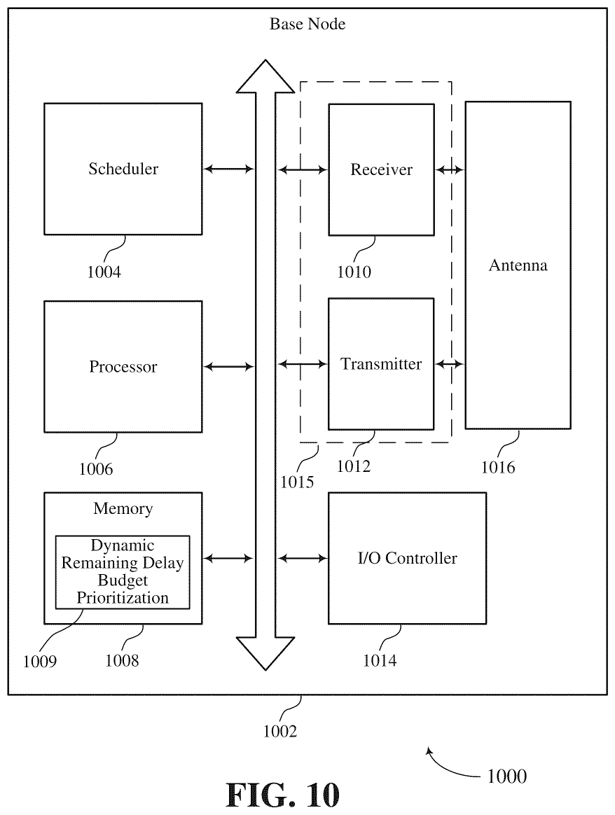

FIG. 10 presents an example of a block diagram 1000 of a network device 1002 enabling wireless communication that supports an LCP procedure enhanced for latency-sensitive traffic such as XR traffic, in accordance with aspects of the present disclosure. The network device 1002 may be an example of a base station 102 or a base node, as described herein. The network device 1002 may support wireless communication with one or more base stations 102 and core network 106 as described in FIG. 1, UEs 104, or any combination thereof. The network device 1002 may include components for bi-directional communications including components for transmitting and receiving communications, such as a scheduler 1004, a processor 1006, a memory 1008, a receiver 1010, transmitter 1012, and an I/O controller 1014. These components may be in electronic communication or otherwise coupled (e.g., operatively, communicatively, functionally, electronically, electrically) via one or more interfaces (e.g., buses). The receiver 1010 and transmitter 1012 may be located on a single chip and collectively referred to as a transceiver 1015.

The scheduler 1004, the receiver 1010, the transmitter 1012, or various combinations thereof or various components thereof may be examples of means for performing various aspects of the present disclosure as described herein. For example, the scheduler 1004, the receiver 1010, the transmitter 1012, or various combinations or components thereof may support a method for performing one or more of the functions described herein.

In some implementations, the scheduler 1004, the receiver 1010, the transmitter 1012, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1006 and the memory 1008 coupled with the processor 1006 may be configured to perform one or more of the functions described herein (e.g., by executing, by the processor 1006, instructions stored in the memory 1008). In an example, the processor 1006 executes a dynamic RGB prioritization application 1009 that configures the scheduler 1004 to perform an enhanced LCP procedure scheduling a user device such as UE 104 (FIG. 1) for either prioritizing latency-sensitive data for assignment to an uplink signal or reverting to LCH prioritization for other traffic or data.

Additionally, or alternatively, in some implementations, the scheduler 1004, the receiver 1010, the transmitter 1012, or various combinations or components thereof may be implemented in code (e.g., as communications management software or firmware) executed by the processor 1006. If implemented in code executed by the processor 1006, the functions of the scheduler 1004, the receiver 1010, the transmitter 1012, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the scheduler 1004 may be configured to perform various operations (e.g., receiving, monitoring, transmitting) using or otherwise in cooperation with the receiver 1010, the transmitter 1012, or both. For example, the scheduler 1004 may receive information from the receiver 1010, send information to the transmitter 1012, or be integrated in combination with the receiver 1010, the transmitter 1012, or both to receive information, transmit information, or perform various other operations as described herein. Although the scheduler 1004 is illustrated as a separate component, in some implementations, one or more functions described with reference to the scheduler 1004 may be supported by or performed by the processor 1006, the memory 1008, or any combination thereof. For example, the memory 1008 may store code, which may include instructions executable by the processor 1006 to cause/configure the network device 1002 to perform various aspects of the present disclosure as described herein, or the processor 1006 and the memory 1008 may be otherwise configured to perform or support such operations.

The processor 1006 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1006 may be configured to operate a memory array using a memory controller. In some other implementations, a memory controller may be integrated into the processor 1006. The processor 1006 may be configured to execute computer-readable instructions stored in a memory (e.g., the memory 1008) to cause the network device 1002 to perform various functions of the present disclosure.

The memory 1008 may include random access memory (RAM) and read-only memory (ROM). The memory 1008 may store computer-readable, computer-executable code including instructions that, when executed by the processor 1006 cause the network device 1002 to perform various functions described herein. The code may be stored in a non-transitory computer-readable medium such as system memory or another type of memory. In some implementations, the code may not be directly executable by the processor 1006 but may cause/configure a computer (e.g., when compiled and executed) to perform functions described herein. In some implementations, the memory 1008 may include, among other things, a basic I/O system (BIOS) which may control basic hardware or software operation such as the interaction with peripheral components or devices.

The I/O controller 1014 may manage input and output signals for the network device 1002. The I/O controller 1014 may also manage peripherals not integrated into the network device 1002. In some implementations, the I/O controller 1014 may represent a physical connection or port to an external peripheral. In some implementations, the I/O controller 1014 may utilize an operating system such as iOS®, ANDROID®, MS-DOS®, MS-WINDOWS®, OS/2®, UNIX®, LINUX®, or another known operating system. In some implementations, the I/O controller 1014 may be implemented as part of a processor, such as the processor 1006. In some implementations, a user may interact with the network device 1002 via the I/O controller 1014 or via hardware components controlled by the I/O controller 1014.

In some implementations, the network device 1002 may include a single antenna 1016. However, in some other implementations, the network device 1002 may have more than one antenna 1016, which may be capable of concurrently transmitting or receiving multiple wireless transmissions. The receiver 1010 and the transmitter 1012 may communicate bi-directionally, via the one or more antennas 1016, wired, or wireless links as described herein. For example, the receiver 1010 and the transmitter 1012 may represent a wireless transceiver and may communicate bi-directionally with another wireless transceiver. The transceiver may also include a modem to modulate the packets, to provide the modulated packets to one or more antennas 1016 for transmission, and to demodulate packets received from the one or more antennas 1016.

In an example, the scheduler 1004 may support wireless communication at a first network device (e.g., the network device 1002) in accordance with examples as disclosed herein. The network device 1002 includes the transceiver 1015 including at least one receiver 1010 and at least one transmitter 1012 that enable the network device 1002 to communicate with a user device such as UE 104 (FIG. 1). The scheduler 1004 is communicatively coupled to the transceiver 1015. According to aspects of the present disclosure, the scheduler 1004 transmits, via the transceiver 1015 on a downlink to the user device, one or more control messages containing: (i) logical channel configuration of more than one logical channels, including a priority value associated with each logical channel; and (ii) an uplink resource allocation grant. The one or more control messages prompt the user device to track respective remaining delay budgets for each packet data unit (PDU) in one or more uplink buffers assigned to a corresponding one of the more than one logical channels. In addition, the one or more control messages prompt the user device to determine, on a medium access control layer, a multiplexing order of the PDUs of the more than one logical channels according to the associated remaining delay budget in increasing order starting with the PDU having smallest remaining delay budget. In addition, the one or more control messages prompt the user device to assign resources allocated by the uplink grant to the logical channels according to the determined multiplexing order starting with the logical channel having the PDU with the smallest remaining delay budget, Further, the one or more control messages prompt the user device to receive from the user device, via the transceiver 1015 on the medium access control layer, an uplink signal containing the PDUs of the more than one logical channels multiplexed by the user device according to the assigned resources.

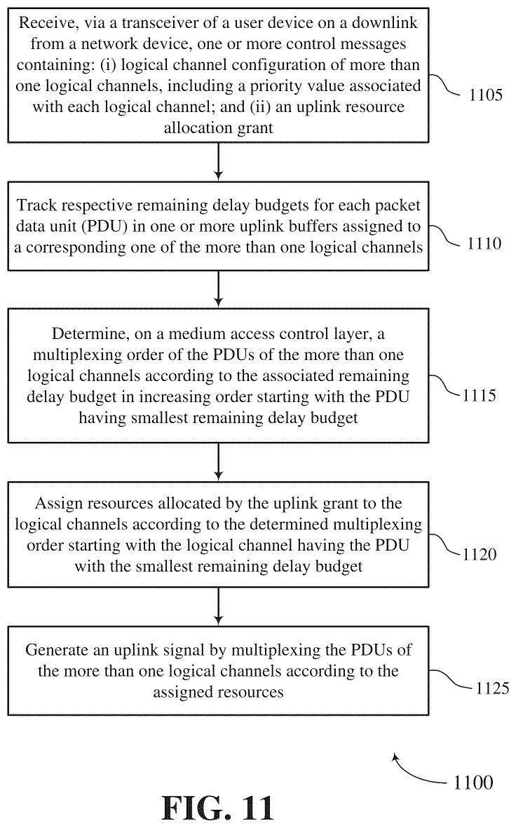

FIG. 11 presents a flowchart of a method 1100 that supports wireless communication by a user device with a network device that enhances an LCP procedure for latency-sensitive traffic or data such as XR traffic, in accordance with aspects of the present disclosure. The operations of the method 1100 may be implemented by a user device or its components as described herein. For example, the operations of the method 11 may be performed by a UE 114 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1105, the method 1100 may include receiving, via a transceiver of a user device on a downlink from a network device, one or more control messages containing: (i) logical channel configuration of more than one logical channels, including a priority value associated with each logical channel; and (ii) an uplink resource allocation grant. The operations of 1105 may be performed in accordance with examples as described herein. In some implementations, aspects of the operations of 1105 may be performed by a device as described with reference to FIG. 1 or 9.

At 1110, the method 1100 may include tracking respective remaining delay budgets for each packet data unit (PDU) in one or more uplink buffers assigned to a corresponding one of the more than one logical channels. The operations of 1110 may be performed in accordance with examples as described herein. In some implementations, aspects of the operations of 1110 may be performed by a device as described with reference to FIG. 1 or 9.

At 1115, the method 1100 may include determining, on a medium access control layer, a multiplexing order of the PDUs of the more than one logical channels according to the associated remaining delay budget in increasing order starting with the PDU having smallest remaining delay budget. The operations of 1115 may be performed in accordance with examples as described herein. In some implementations, aspects of the operations of 1115 may be performed by a device as described with reference to FIG. 1 or 9.

At 1120, the method 1100 may include assigning resources allocated by the uplink grant to the logical channels according to the determined multiplexing order starting with the logical channel having the PDU with the smallest remaining delay budget. The operations of 1120 may be performed in accordance with examples as described herein. In some implementations, aspects of the operations of 1120 may be performed by a device as described with reference to FIG. 1 or 9.

At 1125, the method 1100 may include generating an uplink signal by multiplexing the PDUs of the more than one logical channels according to the assigned resources. The operations of 1120 may be performed in accordance with examples as described herein. In some implementations, aspects of the operations of 1125 may be performed by a device as described with reference to FIG. 1 or 9.

In one or more embodiments, the method 1100 includes, in response to determining that the one or more uplink buffers contain latency-sensitive data, transmitting a buffer status report to the network device, the buffer status report indicating a capacity to multiplex an uplink signal. The method 1100 further includes generating the uplink signal by multiplexing the PDUs in response to receiving logical channel prioritization configuration information from the network device prompted by the buffer status report.

In one or more particular embodiments, the method 1100 includes determining that the one or more uplink buffers contain latency-sensitive data by identifying extended reality (XR) data within the one or more uplink buffers. In one or more particular embodiments, the method 1100 includes reverting to assigning PDUs to an uplink signal according to the priority value associated with each of the more than one logical channels in response to determining that the one or more uplink buffers no longer contain latency sensitive data.

In one or more embodiments, one or more control messages include downlink control information (DCI). In one or more embodiments, the PDU is a radio link control (RLC) PDU. The method 1100 further includes determining a remaining delay budget of a particular RLC PDU by identifying a parameter of each RLC service data unit (SDU) of a logical channel that is associated with a respective remaining delay budget.

In one or more embodiments, the method 1100 includes, in response to receiving a configured uplink grant of two or more uplink resources separated in time within a configured grant period, transmitting a multiplexed uplink signal in one of the two or more uplink resources that is scheduled to occur next, enabling the network device to reschedule any subsequent unused uplink resources of the two or more uplink resources.

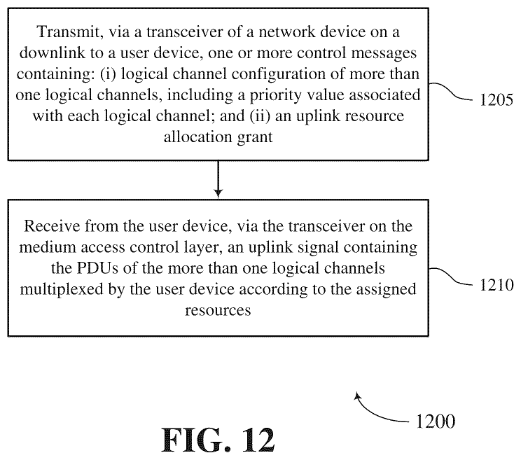

FIG. 12 presents a flowchart of a method 1200 that that supports wireless communication by network device with a user device that enhances an LCP procedure for latency-sensitive traffic or data such as XR traffic, in accordance with aspects of the present disclosure. The operations of the method 1200 may be implemented by a device or its components as described herein. For example, the operations of the method 1200 may be performed by a network device, base node, or base station 102 as described with reference to FIGS. 1 through 10. In some implementations, the network device may execute a set of instructions to control the function elements of the network device to perform the described functions. Additionally, or alternatively, the network device may perform aspects of the described functions using special-purpose hardware.

At 1205, the method may include transmitting, via a transceiver of a network device on a downlink to a user device, one or more control messages containing: (i) logical channel configuration of more than one logical channels, including a priority value associated with each logical channel; and (ii) an uplink resource allocation grant. The operations of 1205 may be performed in accordance with examples as described herein. In some implementations, aspects of the operations of 1205 may be performed by a device as described with reference to FIG. 1 or 10.

The one or more control messages prompt the user device to: (i) track respective remaining delay budgets for each packet data unit (PDU) in one or more uplink buffers assigned to a corresponding one of the more than one logical channels; (ii) determine, on a medium access control layer, a multiplexing order of the PDUs of the more than one logical channels according to the associated remaining delay budget in increasing order starting with the PDU having smallest remaining delay budget; and (iii) assign resources allocated by the uplink grant to the logical channels according to the determined multiplexing order starting with the logical channel having the PDU with the smallest remaining delay budget.

At 1210, the method may include receiving from the user device, via the transceiver on the medium access control layer, an uplink signal containing the PDUs of the more than one logical channels multiplexed by the user device according to the assigned resources. The operations of 1210 may be performed in accordance with examples as described herein. In some implementations, aspects of the operations of 1210 may be performed by a device as described with reference to FIG. 1 or 10.

In one or more embodiments, the method 1200 includes receiving a buffer status report from the user device. The buffer status report indicates a capacity to multiplex an uplink signal based on one or more uplink buffers of the user device containing latency-sensitive data. The method 1200 further includes, in response to the buffer status report, transmitting the one or more control messages to configure the user device to multiplex the PDUs in the uplink signal.

In one or more particular embodiments, the latency-sensitive data includes extended reality (XR) data. In one or more particular embodiments, the method 1000 includes, in response to receiving a second buffer status report indicating that the one or more uplink buffer no longer contains latency-sensitive data, transmitting a second one or more control messages configuring the user device to revert to assigning PDUs to a second uplink signal according to the priority value associated with each of the more than one logical channels.

In one or more embodiments, one or more control messages include downlink control information (DCI). In one or more embodiments, the PDU is a radio link control (RLC) PDU. The method 1200 further includes determining a remaining delay budget of a particular RLC PDU by identifying a parameter of each RLC service data unit (SDU) of a logical channel that is associated with a respective remaining delay budget.

In one or more embodiments, the method 1200 includes transmitting, to the user device, a configured uplink grant of two or more uplink resources separated in time within a configured grant period. The method 1200 includes receiving, from the user device, a multiplexed uplink signal in one of the two or more uplink resources that is scheduled to occur next. The method 1200 includes rescheduling any subsequent unused uplink resources of the two or more uplink resources.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1-20. (canceled)

21. A user equipment (UE) for wireless communication, the UE comprising:
at least one memory; and
at least one processor coupled with the at least one memory and configured to cause the UE to:
receive, from a base station, a configured grant (CG) configuration comprising a field that indicates an allocation of multiple configured grant uplink (UL) resources within each CG period; and
use the multiple CG UL resources within a CG period as configured UL grants.

22. The UE of claim 1, wherein the field comprises a parameter indicating a timing of additional CG UL resources within the CG period.

23. The UE of claim 1, wherein the received CG configuration allocates additional CG UL resources ‘x’ slots or ms after a first CG UL resource, wherein the first CG UL resource is determined by a formula.

24. The UE of claim 1, wherein the at least one processor is further configured to cause the UE to:
receive a configured UL grant configuration of two or more CG UL resources separated in time within a CG period; and
in response to receiving the configured UL grant configuration of two or more CG UL resources separated in time within the CG period, transmit, to the base station, an UL signal in one of the two or more CG UL resources that is scheduled to occur next, wherein the base station is able to reschedule any subsequent unused CG UL resources of the two or more CG UL resources based on the UL signal.

25. The UE of claim 1, wherein the at least one processor is further configured to cause the UE to:
perform UL transmission on at least one CG UL resource of multiple CG UL resources allocated within a same CG period; and
following the UL transmission on the at least one CG UL resource, skip any remaining CG UL resources of the multiple CG UL resources allocated within the same CG period.

26. The UE of claim 25, wherein the at least one processor is further configured to cause the UE to:
transmit a notification to the base station to indicate unused CG UL resources within the CG period.

27. A method performed by a user equipment (UE), the method comprising:
receiving, from a base station, a configured grant (CG) configuration comprising a field that indicates an allocation of multiple configured grant uplink (UL) resources within each CG period; and
using the multiple CG UL resources within a CG period as configured UL grants.

28. The method of claim 27, wherein the field comprises a parameter indicating a timing of additional CG UL resources within the CG period.

29. The method of claim 27, wherein the received CG configuration allocates additional CG UL resources ‘x’ slots or ms after a first CG UL resource, wherein the first CG UL resource is determined by a formula.

30. The method of claim 27, further comprising:
receiving a configured UL grant configuration of two or more CG UL resources separated in time within a CG period; and
in response to receiving the configured UL grant configuration of two or more CG UL resources separated in time within the CG period, transmitting, to the base station, an UL signal in one of the two or more CG UL resources that is scheduled to occur next, wherein the base station is able to reschedule any subsequent unused CG UL resources of the two or more CG UL resources based on the UL signal.

31. The method of claim 1, further comprising:
performing UL transmission on at least one CG UL resource of multiple CG UL resources allocated within a same CG period; and
following the UL transmission on the at least one CG UL resource, skipping any remaining CG UL resources of the multiple CG UL resources allocated within the same CG period.

32. The method of claim 31, further comprising:
transmitting a notification to the base station to indicate unused CG UL resources within the CG period.

33. A base station for wireless communication, the base station comprising:
at least one memory; and
at least one processor couple with the at least one memory and configured to cause the base station to:
transmit, to a user equipment (UE), a configured grant (CG) configuration comprising a field that indicates an allocation of multiple configured grant (CG) uplink (UL) resources within each CG period.

34. The base station of claim 33, wherein the field comprises a parameter indicating a timing of additional CG UL resources within the CG period.

35. The base station of claim 33, wherein the received CG configuration allocates additional CG UL resources ‘x’ slots or ms after a first CG UL resource, wherein the first CG UL resource is determined by a formula.

36. The base station of claim 33, wherein the at least one processor is further configured to cause the base station to:
receive, from the UE, an UL signal containing the UL traffic within a next CG UL resource.

37. The base station of claim 36, wherein the at least one processor is further configured to cause the base station to:
transmit a configured UL grant configuration of two or more CG UL resources separated in time within a CG period; and
receive an UL signal in one of the two or more UL resources that is scheduled to occur next, wherein the base station is configured to reschedule any subsequent unused CG UL resources of the two or more CG UL resources based on the UL signal.

38. The base station of claim 36, wherein the at least one processor is further configured to cause the base station to:
receive, from the UE, UL transmission on at least one CG UL resource of multiple CG UL resources allocated within a same CG period; and
following the receipt of the UL transmission on the at least one CG UL resource, re-assign any remaining CG UL resources of the multiple CG UL resources allocated within the same CG period.

39. The base station of claim 36, wherein the at least one processor is further configured to cause the base station to:
receive, from the UE, a notification indicating that the UE will not use the remaining CG UL resources within the allocated CG period; and
reassign the remaining CG UL resources.
